(19) United States
(12) Patent Application Publication
(10) Pub. No.: US 2026/0357443 A1
(43) Pub. Date: Nov. 12, 2026

(54) PRODUCTION OF HYDROGEN FROM WATER WITH MAGNETIC NANOPARTICLES

(71) Applicant: Quanto Nano Coöperatie (Cooperative) U.A., AImere (NL)

(72) Inventors: Antonijo Licitar, Zagreb (HR); Marc Sima, Alar (ES)

(73) Assignee: Quanto Nano Coöperatie (Cooperative) U.A., AImere (NL)

(21) Appl. No.: 19/364,575

(22) Filed: Oct. 21, 2025

Related U.S. Application Data
(60) Provisional application No. 63/709,785, filed on Oct. 21, 2024.

(51) Int. Cl. C25B 1/04; C25B 15/08; H01M 8/0656

(52) U.S. Cl. CPC C25B 1/04; C25B 15/087; H01M 8/0656

(57) ABSTRACT

The present disclosure describes systems and methods for producing hydrogen from an aqueous solution. The system may include a reservoir for containing an aqueous solution; a metal component including a metal plate coated with a layer of magnetic nanoparticles in contact with the aqueous solution; and a magnet capable of generating a magnetic field; wherein the magnet is sufficiently proximate to the metal component such that the metal component is within the magnetic field when the magnetic field is induced.

### CROSS-REFERENCE TO RELATED APPLICATIONS

This application claims priority to US Provisional Application No. 63/709,785 filed Oct. 21, 2024, which is incorporated by reference in its entirety.

### FIELD

The present disclosure relates generally to systems and methods for producing hydrogen. More specifically, the present disclosure relates to systems and methods for producing hydrogen from an aqueous solution using a magnetic field.

### BACKGROUND

The need for clean and renewable energy is a critical concern. Renewable energy sources such as sun, wind, and hydropower are important and almost inexhaustible resources. However, the management and distribution of these resources reveal problems in production and storage, which can depend on weather conditions and network demands. Today, these problems are addressed by compensating production deficits with nuclear or thermal power plants, as well as the use of batteries or other methods of energy storage that can store and distribute energy as needed in the network or in smaller off-grid systems.

Such storage systems based on batteries are expensive and have their own environmental drawbacks. Therefore, current research on developing more eco-friendly systems is directed towards hydrogen fuel cells because of their high efficiency, longevity, and almost negligible negative impact on our environment. Current hydrogen fuel cells are mostly powered by hydrogen obtained from fuel gas separation as the most cost-effective method, and to a lesser extent, hydrogen obtained from water via electrolysis. Extracting hydrogen from gases requires an energy input or a catalyst to produce hydrogen.

Electrolysis of water is the cleanest method of hydrogen production currently available, as it simultaneously releases oxygen as a by-product in open systems and also allows for the use of seawater to produce potable water, another crucial resource. Current methods of hydrogen production, storage, and distribution have several significant limitations, including the use of expensive and fragile electrolyzer stacks, the requirement for mined raw earth metals, and low efficiency, as well as significant safety concerns. Additionally, the need to store or liquefy hydrogen requires additional energy input. There remains a need for efficient, cost-effective, and on-demand hydrogen production.

### SUMMARY

In some aspects, the techniques described herein relate to a system for producing hydrogen, including: a reservoir for containing an aqueous solution; a metal component including a metal plate coated with a layer of magnetic nanoparticles in contact with the aqueous solution; and a magnet capable of generating a magnetic field; wherein the magnet is sufficiently proximate to the metal component such that the metal component is within the magnetic field when the magnetic field is induced.

In some aspects, the techniques described herein relate to a system, wherein the metal plate includes iron, nickel, cobalt, or combinations thereof.

In some aspects, the techniques described herein relate to a system, wherein the magnetic nanoparticles include iron, nickel, cobalt, silicon, or combinations thereof.

In some aspects, the techniques described herein relate to a system, wherein the layer of magnetic nanoparticles includes magnetic nanoparticles in a non-magnetic coating.

In some aspects, the techniques described herein relate to a system, wherein the non-magnetic coating includes an epoxy.

In some aspects, the techniques described herein relate to a system, wherein the magnetic nanoparticles are uniformly coated onto the metal plate.

In some aspects, the techniques described herein relate to a system, wherein the magnetic nanoparticles are coated onto the metal plate in a pattern which enhances the magnetic field.

In some aspects, the techniques described herein relate to a system, wherein the magnet includes a permanent magnet, a temporary magnet, an electromagnet, or combinations thereof.

In some aspects, the techniques described herein relate to a system, wherein the magnet is arranged in a parallel arrangement, a series arrangement, a Halbach array, or a ring-shaped Halbach array.

In some aspects, the techniques described herein relate to a system, further including a housing.

In some aspects, the techniques described herein relate to a system, further including an apparatus for collecting a gas, storing a gas, transferring a gas, or combinations thereof.

In some aspects, the techniques described herein relate to a method of using the system of any of the above aspects to produce hydrogen.

In some aspects, the techniques described herein relate to a method, including applying a magnetic field to the system.

In some aspects, the techniques described herein relate to a method of producing hydrogen, including: contacting a metal component with an aqueous solution, the metal component including: a metal plate coated with a layer of magnetic nanoparticles; and applying a magnetic field to the aqueous solution; thereby producing hydrogen.

In some aspects, the techniques described herein relate to a method, wherein the aqueous solution is acidic.

In some aspects, the techniques described herein relate to a method, wherein the aqueous solution is alkaline.

In some aspects, the techniques described herein relate to a method, further including recycling the aqueous solution.

In some aspects, the techniques described herein relate to a method, further including applying an electric current.

In some aspects, the techniques described herein relate to a method, further including collecting the hydrogen.

In some aspects, the techniques described herein relate to a method, further including transferring the hydrogen to a fuel cell.

### BRIEF DESCRIPTION OF THE DRAWINGS

Aspects, features, benefits, and advantages of the embodiments described herein will be apparent with regard to the following description, appended claims, and accompanying drawings where:

FIG. 1 is an illustrative depiction of a system for producing hydrogen, according to an embodiment of the present disclosure.

FIG. 2 is a flow chart of a method for producing hydrogen, according to an embodiment of the present disclosure.

### DETAILED DESCRIPTION

The present disclosure describes systems and methods for producing hydrogen using a magnetic field. External energy sources are not required, but may be used to enhance the rate or efficiency of the process.

The magnetic properties of materials stem from the magnetic moments of atoms and their interactions, which can create collective magnetic ordering. The magnetism of atoms results from the magnetism of electrons and atomic nuclei and interactions thereof. There are orbital magnetic moments, due to the motion of electrons around the atomic nucleus, and spin magnetic moments, as an intrinsic quantum mechanical property of electrons and nuclei. Based on behavior in a magnetic field, all substances are characterized by their magnetic permeability, and can be classified as diamagnetic, paramagnetic, ferromagnetic, ferrimagnetic, and antiferromagnetic.

The methods of the present disclosure enable the production of hydrogen from water using a permeable or electro-induced magnetic field and its flow in a configuration that does not require external energy input into the system. The present methods utilize the natural phenomenon of magnetism and the interaction of hydrogen and oxygen, such as in water, with a magnetic field.

Water molecules do not exist independently but form clusters (macromolecules) due to the attraction of a positive hydrogen of one molecule to a negative oxygen of another molecule. Water molecular clusters come in various sizes, depending on the number of molecules that have attracted together.

The effect of an external magnetic field, such as the Earth's magnetic field, is visible in the size and structure of water clusters in different parts of the Earth, depending on the density of magnetic flux, and varies for the north and south poles of the Earth. A magnetic field induced using permeable or electromagnets affects these clusters by breaking them into macromolecules. Under the influence of an externally induced magnetic field and the Earth's magnetic field, the macromolecules interact. The induced dynamics and movement of molecules affect the movement of electrons of hydrogen and oxygen, and the miniature water clusters become polarized; that is, the water clusters tend to orient themselves in the magnetic field.

When a magnetic field is induced upon metals like nickel and iron immersed in water, the different magnetic properties of these metals and the dynamics of the water clusters develop an effect known as eddy currents on the surface of these metals, which are of opposite directions and different frequencies, radii, and strengths on each of the individual metals. Macro clusters of water in such an environment become oriented and cling to the surfaces of the metals.

In the present methods, magnetically induced hydrogen production enables the hydrogen to be obtained from the water by means of a permanent or electro-induced magnetic field and its flow. The configuration of the system requires no external energy input but instead uses the natural phenomenon of magnetism and its interaction with hydrogen and oxygen. The present method can generate hydrogen gas and pure oxygen in high efficiency, both of which are useful and valuable end products.

In embodiments, there is provided a system for producing hydrogen, including: a reservoir for containing an aqueous solution; a metal component including a metal plate coated with a layer of magnetic nanoparticles in contact with the aqueous solution; and a magnet capable of generating a magnetic field; wherein the magnet is sufficiently proximate to the metal component such that the metal component is within the magnetic field when the magnetic field is induced.

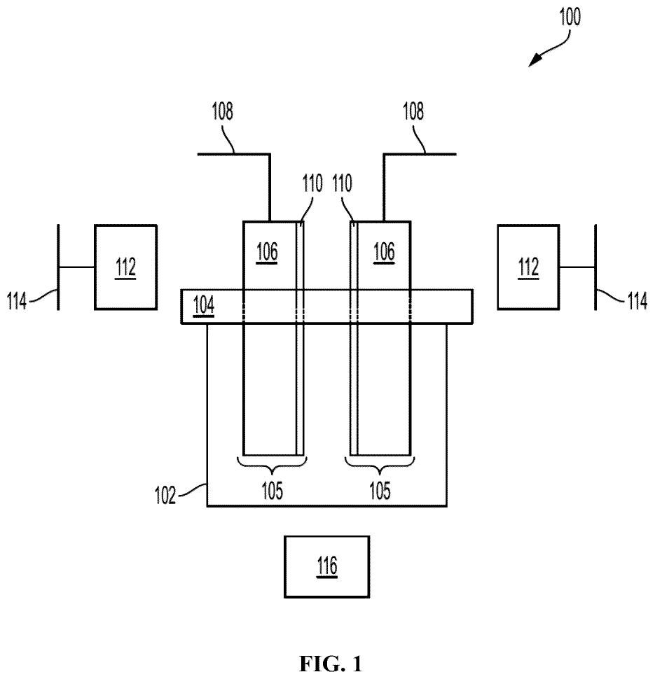

FIG. 1 is an illustrative depiction of a system for producing hydrogen, according to an embodiment of the present disclosure. In embodiments, the system 100 includes a reservoir 102, a lid 104, a metal component 105 which includes a metal plate 106 and a layer of magnetic nanoparticles 110, and a magnet 112.

In embodiments, system 100 includes the reservoir 102. The reservoir 102 may be formed from any material suitable for containing an acidic or alkaline aqueous solution. The reservoir 102 may be open at the top or closed. In embodiments, the reservoir 102 may include the lid 104 which can be opened or closed. In embodiments, the reservoir 102 does not include a lid 104.

In embodiments, the system 100 includes a metal component 105. The metal component 105 may include a metal plate 106 and a layer of magnetic nanoparticles 110. In embodiments, the metal plate 106 includes iron, nickel, cobalt, or combinations thereof. Alloys including iron, nickel, cobalt, or combinations thereof may also be included in the metal plate. In embodiments, the metal plate 106 can include ferromagnetic materials, paramagnetic materials, other magnetic materials, or combiantions thereof. In embodiments, the metal plate 106 may be substantially rectangular. In other embodiments, the metal plate 106 may be rod-shaped. The metal plate 106 may be connected to the system such that the metal plate 106 can be raised or lowered into the aqueous solution. For example, the metal component 105 may be operatively connected to a positioning apparatus 108. In embodiments, the metal component 105 is fixed, and the system 100 does not include the positioning apparatus 108. In embodiments wherein the reservoir is closed or includes a lid 104 which allows the reservoir 102 to be closed, the metal component 105 may be configured to fit within a slot 107 in the lid such that the metal component 105 is in contact with the aqueous solution. In embodiments, the metal component 105 is connected to an underside of the lid 109, such that the metal plate 105 is in contact with the aqueous solution when the lid 104 is closed.

In embodiments, the metal component 105 includes a plurality of metal plates, which may be of the same or different shapes or configurations as described herein. For example, in embodiments, the system may include 1, 2, 3, 4, 5, or more metal plates. The number, size, and dimensions of the metal plate(s) may be adjusted to influence the magnetic field.

In embodiments, the metal plate 106 can be coated with a layer of magnetic nanoparticles 110. In embodiments, the layer of magnetic nanoparticles 110 is uniformly coated onto the metal plate. In embodiments, the layer of magnetic nanoparticles 110 is coated onto the metal plate in a pattern which enhances an applied magnetic field. The layer of magnetic nanoparticles 110 may be coated onto the metal plate in any method suitable for coating nanoparticles onto a metal substrate. In embodiments, the layer of magnetic nanoparticles 110 can be a nanoscale coating or a microscale coating. For example, in embodiments, the layer of magnetic nanoparticles 110 can have a thickness of about 1 nm about to about 500 μm, such as about 1 nm, about 10 nm, about 50 nm, about 100 nm, about 200 nm, about 300 nm, about 400 nm, about 500 nm, about 600 nm, about 700 nm, about 800 nm, about 900 nm, about 1 μm, about about 10 μm, about 50 μm, about 100 μm, about 200 μm, about 300 μm, about 400 μm, about 500 μm, or any value contained within a range formed by any two of the preceding values.

In embodiments, the magnetic nanoparticles can be incorporated into the metal plate 106. In embodiments, the magnetic nanoparticles can be distributed throughout the metal plate 106, or the metal plate 106 can serve as a magnetic component.

In embodiments, the magnetic nanoparticles include iron, nickel, cobalt, or combinations thereof. Alloys or compounds including iron, nickel, cobaltor combinations thereof are also contemplated. For example, in embodiments, the magnetic nanoparticles may include magnetite or other permeable magnetic materials, or combinations of such materials. In embodiments, the magnetic nanoparticles can include crystalline materials such as silicon, wherein the crystalline structure may be influenced by an applied magnetic field. The layer of magnetic nanoparticles 110 may also include carbon allotropes such as nanographene and the like. The layer of magnetic nanoparticles 110 may enhance the magnetic field and aid in directing the water molecules to favor dissociation, thus increasing the production of hydrogen. It is contemplated that the layer of magnetic nanoparticles 110 may cause formation of eddy currents that act on the magnetic moment of the water clusters. This action on the magnetic moment corresponds to the hydrogen spin configuration inside of the water molecules and the reestablishment of the dynamic equilibrium state (which is perturbed by release of oxygen), therefore encouraging the hydrogen-oxygen bond to break and thus producing hydrogen and oxygen from water.

In embodiments, the layer of magnetic nanoparticles 110 includes magnetic nanoparticles in a non-magnetic coating. In embodiments, the non-magnetic coating includes an epoxy. Other non-magnetic coatings that are resistant to corrosion by an acid or a base may also be used. It is contemplated that other binder materials which are at least somewhat conductive may be used as the non-magnetic coating.

In embodiments, the system 100 includes a magnet 112. In embodiments, the magnet may include a permanent magnet, a temporary magnet, an electromagnet, or combinations thereof. The magnet may include a plurality of magnets capable of generating a magnetic field. In embodiments, the magnet is sufficiently proximate to the metal component such that the metal component is within the magnetic field when the magnetic field is induced.

In embodiments, the magnet includes a plurality of magnets arranged in a parallel arrangement, a series arrangement, a Halbach array, or a ring-shaped Halbach array. In embodiments, the magnet 112 is connected and/or contained in a magnet holder 114.

In embodiments, the system 100 further includes an apparatus 116 for the generation of an electric current. The apparatus 116 may be operatively connected to the metal component 105 to provide a current to the system. In embodiments, apparatus 116 has an on/off switch such that current may be provided to the system on demand, such that a current may be provided intermittently. In embodiments, the system does not include the apparatus 116.

In embodiments, the system 100 further includes a housing 118. The housing may enclose the entirety of the system 100, or the housing may enclose one or more parts of the system 100.

In embodiments, the system further includes an apparatus (not shown) for collecting a gas, storing a gas, transferring a gas, or combinations thereof. For example, the system may include and be operatively connected to an apparatus for storing, transferring, or otherwise utilizing hydrogen. In embodiments, the system can further include components (not shown in FIG. 1) such as a water storage container, a pH meter, one or more pumps, a Tesla valve, an hydrogen separation device, a dehumidifier, a power supply for additional treatment of electrodes, a power supply for pulsing magnetic current, or combinations thereof.

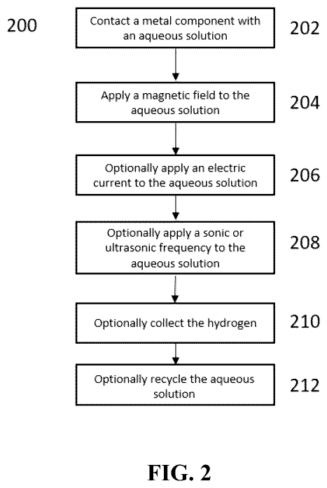

In embodiments, there is provided a method of using the system as described herein for the production of hydrogen. FIG. 2 is a flow chart of a method for producing hydrogen, according to an embodiment of the present disclosure.

In embodiments, there is provided a method of producing hydrogen 200, including: contacting a metal component with an aqueous solution 202, wherein the metal component includes a metal plate coated with a layer of magnetic nanoparticles; applying a magnetic field to the aqueous solution 204; optionally applying an electric current to the aqueous solution 206; and optionally applying a sonic or ultrasonic frequency to the aqueous solution 208; thereby producing hydrogen. In embodiments, the method can include optionally collecting the hydrogen 210. In embodiments, the method can further optionally include recycling the aqueous solution 212.

In embodiments, contacting the metal component with the aqueous solution 202 includes immersing the metal component in the aqueous solution, flowing the aqueous solution over the metal component, or combinations thereof. The metal component may be a metal component as described herein, such as a metal plate coated with a layer of magnetic nanoparticles.

In embodiments, the aqueous solution is acidic. For example, the aqueous solution may have a pH of about 1 to about 6.5, such as about 1, about 2, about 3, about 4, about 5, about 6, about 6.5, or any value contained within a range formed by any two of the preceding values. The aqueous solution may include an acid dissolved in water, such as sulfuric acid, phosphoric acid, nitric acid, the like, or combinations thereof.

In embodiments, the aqueous solution is alkaline. For example, the aqueous solution may have a pH of about 7.5 to about 14, such as about 7.5, about 8, about 9, about 10, about 11, about 12, about 13, about 14, or any value contained within a range formed by any two of the preceding values. The aqueous may include a base dissolved in water, such as sodium hydroxide, potassium hydroxide, the like, or combinations thereof.

The aqueous solution may, in embodiments, include an electrolyte. The electrolyte may include sulfuric acid, phosphoric acid, hydrochloric acid, sodium hydroxide, calcium hydroxide, potassium hydroxide, the like, or combinations thereof. In embodiments, the electrolyte can include acids, bases, salts, or combinations thereof. In embodiments, the aqueous solution includes seawater or other non-potable water.

Applying a magnetic field to the aqueous solution 204 may include, in embodiments, introducing a magnet or plurality of magnets to the metal component and the aqueous solution, such that the magnet is sufficiently proximate to the metal component so that the metal component is within the magnetic field and can be influenced by the magnet field. Electromagnets, permanent magnets, or other sources of magnetism can be used in step 204 of the present method.

Hydrogen is diamagnetic (repelled by an externally applied magnetic field) while oxygen is paramagnetic (attracted by an externally applied magnetic field). Oxygen forms internal, induced magnetic fields in the direction of the applied magnetic field while hydrogen forms induced magnetic fields in the opposite direction to that of the applied magnetic field. It is contemplated that the hydrogens of a water cluster orient towards the south pole of the magnetic field, while the oxygens of a water cluster orient towards the north pole. The overall dynamic and continuous reestablishment of the state of energy equilibrium is manifested in the weakening of the intramolecular bonds of the water molecules and thus encourages dissociation by micro-or nano-eddy currents. The weakening of intramolecular bonds therefore encourages the disassociation of the hydrogen from the oxygen and results in the production of hydrogen.

In embodiments, the method 200 further includes applying an electric current to the aqueous solution 206. It is contemplated that the current applied to the aqueous solution can vary depending on the size and arrangement of the system. An electric current or external power source is not required to produce hydrogen, but may enhance the rate and efficiency of hydrogen production, in embodiments. In embodiments, the method does not include applying an electric current to the aqueous solution, such that no external power source is used.

In embodiments, the method 200 further includes applying a sonic or ultrasonic frequency to the aqueous solution 208, which may encourage the release of hydrogen and oxygen gas from the aqueous solution after the splitting of water. In embodiments, the method does not include applying a sonic or ultrasonic frequency to the aqueous solution.

In embodiments, the method further includes collecting the hydrogen 210. The hydrogen may be stored, transferred, or immediately utilized.

In embodiments, the method 200 further includes recycling the aqueous solution 212. The water remaining after hydrogen production is recyclable and can be returned to the system for further hydrogen production in a closed system, or the water may be collected and transferred in an open system. In embodiments which use non-potable water such as sea water, waste water, and the like, the method 200 can include additional purification or filtration processes to procure potable water. In embodiments, the method 200 can include recycling the aqueous solution without further purification or filtration, and directly returning the aqueous solution to the system.

In embodiments, the method further includes transferring the hydrogen to a fuel cell. The hydrogen may be pumped or filtered to a fuel cell for on-demand use.

### EXAMPLES

The following non-limiting example was carried out according to embodiments of the present disclosure.

Iron plates were sanded with 180 grit sandpaper, cleaned with acetone, and coated by galvanization. The process of galvanization included a metal component made of steel and an electrode attached thereto. Before the galvanization, the plates were furrowed mechanically to provide an effective surface on the plates. After the galvanization, the metal component was smoothed out by mechanical processing.

Two magnets were attached between two nickel-coated iron plates, on each end in the parallel configuration. On one side was a plate with the two north poles of the magnets attached (the “north-plate”) and on the other side was another plate with two south poles of the magnets attached (the “south-plate”).

The metal plate and magnet assembly was placed into an experimental beaker with 615.49 g of 3 vol. % aqueous H₂SO₄. The initial mass of the experimental beaker with the aqueous solution was 778.79 g. The solution was prepared by adding 18 mL of concentrated H₂SO₄ to 582 mL demineralized water. A reference beaker with the same quantity of solution was used.

Two modes of measurement were performed: SONIC (experimental setup immersed into the ultrasonic bath) and non-SONIC (experimental setup outside the sonic bath).

There are three characteristic time intervals during which the measurements were performed.

The basic (standard) measurement has a duration of 1 hour. The night measurement has a duration of approximately 18 hours. The weekend measurement has a duration of approximately 66 hours.

### Non-SONIC Measurement

The experimental beaker was weighed and left to stand for one hour. Then the reference beaker was weighed and left to stand for one hour in the vicinity of the experimental beaker to ensure the same physical conditions of measurement for both the beakers.

At the end of the interval (1 hour, 18 hours, or 66 hours), the bubbles of accumulated gas were removed from the plates and the experimental beaker was weighed. Then the reference beaker was weighed to calculate the mass losses in the beakers during the given time interval.

The estimate of the mass of splitting water from the experimental vessel was obtained taking the difference in the initial and final masses of the experimental beaker, and subtracting that value from the difference in the initial and final mass in the reference beaker. This estimate is more accurate when there is less chemical degradation of the experimental setup.

### SONIC Measurement

The experimental beaker was weighed and placed into an ultrasonic bath in an appropriate basket to stand for one hour. Then the reference beaker was weighed and placed into the ultrasonic bath and left to stand for one hour in the vicinity of the experimental beaker to ensure the same physical conditions of measurement for both the beakers. At the beginning and the end of the measurement time interval, the temperature of the ultrasonic bath was measured.

At the end of the interval (1 or 18 hours), the beakers were removed from the ultrasonic bath and carefully cleaned and dried to avoid water from the ultrasonic bath affecting the final weight measurement.

The bubbles of accumulated gas were removed from the plates, and the experimental beaker and the reference beaker were weighed.

The measurement of pH was performed when signs of chemical degradation were visible (such as a change in the color of the aqueous solution). A decrease in solution concentration can significantly affect the efficiency of the water splitting process, without wishing to be bound by theory. Chemical degradation can also be measured by UV-visible spectroscopy. Monitoring the chemical degradation of the system, if any, can aid in determining whether additional components such as water or a pH adjuster should be added.

### Results

It was determined that the above experiments may be performed with good reproducibility.

The pH of a reference aqueous solution of H₂SO₄ (3% by volume, 50 ml) was measured. The pH of the 3% H₂SO₄ was 0.216 when measured at 22.5 degrees Celsius. The pH of the experimental solution after the above experiment was 0.252. The measurement error was 5%.

It was thus concluded that a chemical reaction occurs between the iron plates and the aqueous solution, which causes chemical degradation of the iron plates and an increase in pH. From the change in pH and visual observation and interaction with the system during the measurements, it was concluded that chemical degradation was occurring. A change in the color of aqueous solution (with the solution turning a pale green) was also observed, which may be ascribed to a chemical reaction between the nickel of the metal plate and sulfuric acid during the experiments. Subsequent experiments demonstrated no change in pH, change in color, or other visual signs of degradation.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

This disclosure is not limited to the particular systems, devices and methods described, as these may vary. The terminology used in the description is for the purpose of describing the particular versions or embodiments only and is not intended to limit the scope.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

As used herein, the term “about” means plus or minus 10% of the numerical value of the number with which it is being used. For example, “about 50%” means in the range of 45-55%, and also includes exactly 50%. That is, any value herein modified by “about” also discloses the value itself.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera. As a non-limiting example, each range discussed herein can be readily broken down into a lower third, middle third and upper third, et cetera. As will also be understood by one skilled in the art all language such as “up to,” “at least,” and the like include the number recited and refer to ranges that can be subsequently broken down into subranges as discussed above. Finally, as will be understood by one skilled in the art, a range includes each individual member. Thus, for example, a group having 1-3 compounds refers to groups having 1, 2, or 3 compounds. Similarly, a group having 1-5 compounds refers to groups having 1, 2, 3, 4, or 5 compounds, and so forth.

Various of the above-disclosed and other features and functions, or alternatives thereof, may be combined into many other different systems or applications. Various presently unforeseen or unanticipated alternatives, modifications, variations, or improvements therein may be subsequently made by those skilled in the art, each of which is also intended to be encompassed by the disclosed embodiments.

EMBODIMENTS

What is claimed is:

1. A system for producing hydrogen, comprising:
a reservoir for containing an aqueous solution;
a metal component comprising a metal plate coated with a layer of magnetic nanoparticles in contact with the aqueous solution; and
a magnet capable of generating a magnetic field;
wherein the magnet is sufficiently proximate to the metal component such that the metal component is within the magnetic field when the magnetic field is induced.

2. The system of claim 1, wherein the metal plate comprises iron, nickel, cobalt, or combinations thereof.

3. The system of claim 1, wherein the magnetic nanoparticles comprise iron, nickel, cobalt, silicon, or combinations thereof.

4. The system of claim 1, wherein the layer of magnetic nanoparticles comprises magnetic nanoparticles in a non-magnetic coating.

5. The system of claim 4, wherein the non-magnetic coating comprises an epoxy.

6. The system of claim 1, wherein the magnetic nanoparticles are uniformly coated onto the metal plate.

7. The system of claim 1, wherein the magnetic nanoparticles are coated onto the metal plate in a pattern which enhances the magnetic field.

8. The system of claim 1, wherein the magnet comprises a permanent magnet, a temporary magnet, an electromagnet, or combinations thereof.

9. The system of claim 1, wherein the magnet is arranged in a parallel arrangement, a series arrangement, a Halbach array, or a ring-shaped Halbach array.

10. The system of claim 1, further comprising a housing.

11. The system of claim 1, further comprising an apparatus for collecting a gas, storing a gas, transferring a gas, or combinations thereof.

12. A method of using the system of claim 1 to produce hydrogen.

13. The method of claim 12, comprising applying a magnetic field to the system.

14. A method of producing hydrogen, comprising:
contacting a metal component with an aqueous solution, the metal component comprising:
a metal plate coated with a layer of magnetic nanoparticles; and
applying a magnetic field to the aqueous solution;
thereby producing hydrogen.

15. The method of claim 14, wherein the aqueous solution is acidic.

16. The method of claim 14, wherein the aqueous solution is alkaline.

17. The method of claim 14, further comprising recycling the aqueous solution.

18. The method of claim 14, further comprising applying an electric current.

19. The method of claim 14, further comprising collecting the hydrogen.

20. The method of claim 14, further comprising transferring the hydrogen to a fuel cell.
